(19) United States
(12) Patent Application Publication
(10) Pub. No.: US 2025/0391989 A1
(43) Pub. Date: Dec. 25, 2025

(54) BATTERY MODULE AND PRESSURE BALANCING UNIT THEREOF

(71) Applicant: Robert Bosch GmbH, Stuttgart (DE)

(72) Inventors: Bernhard Panhoelzl, Weinstadt (DE); Jule Stoll, Wolfschlugen (DE); Jens-Martin Koegel, Stuttgart (DE); Markus Lux, Winnenden (DE)

(21) Appl. No.: 19/249,124

(22) Filed: Jun. 25, 2025

(30) Foreign Application Priority Data
Jun. 25, 2024 (DE) 10 2024 205 925.0

(51) Int. Cl. H01M 50/342; H01M 50/204; H01M 50/224

(52) U.S. Cl. CPC H01M 50/3425; H01M 50/204; H01M 50/224

(57) ABSTRACT

A battery module has a housing, in which a plurality of battery cells can be received. The housing includes a pressure balancing unit, which includes a membrane. The pressure balancing unit includes a cross-sectional area that is an oval and configured as an oblong hole or in a keyhole shape.

### BACKGROUND

The invention relates to a battery module according to the type defined in the disclosure. The subject-matter of the present invention is also a pressure balancing unit.

A battery module comprises a plurality of individual battery cells, each of which has a positive voltage tap and a negative voltage tap, wherein the respective voltage taps are electrically conductively connected to one another for an electrically conductive serial and/or parallel connection of the plurality of battery cells to one another and may thus be interconnected to form the battery module. In particular, the battery cells may each have a first voltage tap, in particular, a positive voltage tap, and a second voltage tap, in particular, a negative voltage tap, which are electrically conductively connected to each other by means of cell connectors, such that an electrically serial and/or parallel interconnection is formed. Battery modules, in turn, are further connected together to form batteries or entire battery systems.

Such battery modules, such as 48-Volt modules, are known to include pressure balancing units, abbreviated PBU, which in particular comprise a circular membrane. They are comparatively small in design and comprise an opening diameter of 4 mm, for example. In a degassing event with a hazard level of 3, where less than 50% of the active material degasses, gas may escape through the membrane. By contract, in a degassing event with a hazard level of 4, where more than 50% of the active material degasses, a housing of the battery module opens at different points so that gas cannot purposefully escape at these points.

Furthermore, such battery modules, such as 48-Volt battery modules, are known to include pressure balancing units that additionally comprise a burst function. In particular, such pressure balancing units can be integrated into a metallic housing of the battery module. Such pressure balancing units are of comparable size and comprise, for example, an opening diameter of greater than 18 mm. Furthermore, these membranes are formed from plastic and are attached to the housing by means of ultrasonic welding. The burst element is arranged downstream of the membrane in the direction of flow of the gas.

Furthermore, it is known to place the burst element directly on the membrane. In this case, the burst element is arranged upstream of the membrane in the direction of flow of the gas. During the degassing process, the membrane is torn off the burst element.

### SUMMARY

A battery module having the features of the disclosure offers the advantage that a battery module can be provided with a comparatively small pressure balancing unit with a burst function, which can also allow all of gas to escape in a degassing event with a hazard level of 4.

According to the invention, a battery module is provided for this purpose. The battery module comprises a housing in which a plurality of battery cells can be received. In particular, battery cells are also housed in the housing. Preferably, each of the battery cells is configured as a lithium-ion battery cell. Furthermore, the housing of the battery module also comprises a pressure balancing unit, which comprises a membrane.

Furthermore, the pressure balancing unit comprise a cross-sectional area that is oval and configured as an oblong hole or in a keyhole shape.

In particular, the battery module is a 48-volt battery module.

In particular, an embodiment according to the invention offers the advantage that a geometry of the pressure balancing unit does not exceed the dimensions of the housing of the battery module, so that the pressure balancing unit has no increased influence on the configuration of the housing of the battery module as well as on the assembly space or the assembly line.

Particularly expedient, the pressure balancing unit comprises a through-opening in which exclusively the membrane is arranged. This offers the particular advantage that a comparatively small pressure balancing unit can be provided by means of such an embodiment. The pressure balancing unit is exclusively secured by the membrane. In particular, an additional burst element can thus be omitted with, in particular a burst element can be omitted within the through-opening.

Advantageously, the through-opening of the pressure balancing unit has a surface area of between 100 mm² and 250 mm². In particular, the area is less than 200 mm². A reliable degassing can thereby also be formed in the degassing event with a hazard level of 4. Thus, by means of the oval configuration of the opening formed as an oblong hole or in a keyhole shape, a comparably small surface area of the opening can be provided.

It is advantageous when the membrane of the pressure balancing unit is made from plastic. In particular, the plastic is polytetrafluorethylene or polyethylene terephthalate. This provides the advantage that a reliably formed membrane can be provided.

It is expedient when the housing of the battery module is formed from a metallic material. The metallic material is configured in particular as aluminum. This provides the advantage that a reliable reception of a plurality of battery cells is possible.

It is expedient when the pressure balancing unit comprises a frame element, wherein the frame element is arranged on the housing of the battery module in a materially-locking manner, in particular welded and preferably laser-welded or also glued. This makes it possible to provide a tightly formed connection, such that suitable sealing specifications between the pressure balancing unit and the housing of the battery module, such as IP6K7, can be met.

Preferably, the frame element is configured asymmetrically in this case. In particular, the frame element comprises circumferentially a protrusion or an edge or a support element, which projects into the through-opening. As a result, a sufficient surface area can be provided for the formation of the materially-locking connection.

At this point, it should be noted that the frame element can, of course, also be symmetrical.

At this point, it should be noted that, by means of an embodiment of the battery module according to the invention and the pressure balancing unit, overall costs can be reduced compared to known solutions from the prior art.

The subject-matter of the present invention is also a pressure balancing unit of a battery module, which comprises a membrane, as described above. The pressure balancing unit comprises a cross-sectional area that is an oval and configured as an oblong hole or in a keyhole shape.

Of course, the pressure balancing unit can be enhanced with all further developments described in connection with the battery module.

### BRIEF DESCRIPTION OF THE DRAWINGS

Exemplary embodiments of the invention are shown in the drawings and explained in more detail in the following description.

Shown are:

FIG. 1 a cutout of an embodiment of a battery module according to the invention in an external view,

FIG. 2 a cutout of an embodiment of a battery module according to the invention in a sectional view, and

FIG. 3 a perspective view of a pressure balancing unit of a battery module according to the invention.

### DETAILED DESCRIPTION

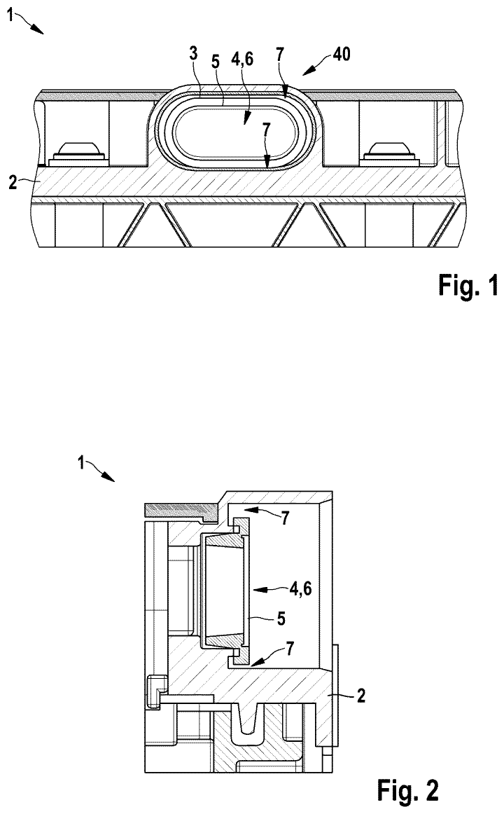

FIG. 1 shows a cutout of an embodiment of a battery module 1 according to the invention in an external view.

The battery module 1 comprises a housing 2 in which a plurality of battery cells (not discernible in FIGS. 1 to 3) can be seen. This housing 2 of the battery module 1 is made of a metallic material, in particular aluminum.

Furthermore, the housing 2 of the battery module 1 comprises a pressure balancing unit 3. This pressure balancing unit 3 further comprises a membrane 4. This membrane 4 of the pressure balancing unit 3 is made from a plastic, preferably polytetrafluorethylene or polyethylene terephthalate.

It can be seen from FIG. 1 that the pressure balancing unit 3 comprises a cross-sectional area 40, which is configured as an oblong hole.

The pressure balancing unit 3 further comprises a through-opening 5 in which exclusively the membrane 4 is arranged.

This through-opening 5 of the pressure balancing unit 3 has a surface area 6 of between 100 mm² and 250 mm².

The pressure balancing unit 3 further comprises a frame element 7. The frame element 7 is arranged on the housing 2 of the battery module 1 in a materially-locking manner, such as in particular welded and preferably laser-welded or also glued.

FIG. 2 shows a cutout of an embodiment of a battery module 1 according to the invention in a sectional view.

The through-opening 5 in which the membrane 4 is arranged can first be seen. Furthermore, the frame element 7 can be seen, which is arranged in a materially-locking manner on the housing 2.

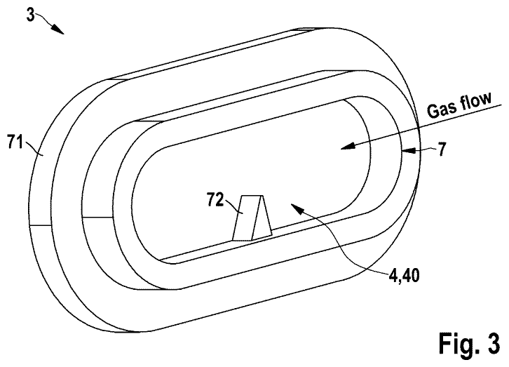

FIG. 3 shows a perspective view of a pressure balancing unit 3 of a battery module 1 according to the invention.

The frame element 7 as well as the membrane 4 can be seen here. Furthermore, it can be seen that the pressure balancing unit 3 comprises a cross-sectional area 40 configured as an oblong hole.

The frame element 7 is configured asymmetrically. It comprises a protrusion 71 or a support element 72. This support element 72 serves as a destroying element in a possible burst event.

1. A battery module having a housing (2), in which a plurality of battery cells can be received, wherein the housing (2) comprises a pressure balancing unit (3), which comprises a membrane (4), wherein the pressure balancing unit (3) comprises a cross-sectional area (40) that is an oval and configured as an oblong hole or in a keyhole shape.

2. The battery module according to claim 1, wherein the pressure balancing unit (3) comprises a through-opening (5), in which exclusively the membrane (4) is arranged.

3. The battery module according to claim 1, wherein the through-opening (5) of the pressure balancing unit (3) comprises a surface area (6) between 100 mm² and 250 mm².

4. The battery module according to claim 1, wherein the membrane (4) of the pressure balancing unit (3) is made of plastic.

5. The battery module according to claim 1, wherein the housing (2) of the battery module (1) is made from a metallic material.

6. The battery module according to claim 1, wherein the pressure balancing unit (3) comprises a frame element (7), wherein the frame element (7) is arranged on the housing (2) of the battery module (1) in a materially-locking manner.

7. The battery module according to claim 6, wherein the frame element (7) is configured asymmetrically.

8. A pressure balancing unit of a battery module (1), comprising a membrane (4), wherein the pressure balancing unit (3) comprises a cross-sectional area (4) that is an oval and configured as an oblong hole or in a keyhole shape.

9. The battery module according to claim 3, wherein the through-opening (5) of the pressure balancing unit (3) comprises a surface area (6) less than 200 mm².

10. The battery module according to claim 4, wherein the membrane (4) of the pressure balancing unit (3) is made of polytetrafluorethylene or polyethylene terephthalate.

11. The battery module according to claim 5, wherein the housing (2) of the battery module (1) is made from aluminum.

12. The battery module according to claim 6, wherein the frame element (7) is welded or glued to the housing (2) of the battery module (1).
